(19) United States
(12) Patent Application Publication
(10) Pub. No.: US 2010/0034120 A1
(43) Pub. Date: Feb. 11, 2010

(54) COMMUNICATION APPARATUS AND CONTROL METHOD THEREFOR

(75) Inventor: Takafumi Nakajima, Mitaka-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/537,123

(22) Filed: Aug. 6, 2009

(30) Foreign Application Priority Data
Aug. 8, 2008 (JP) 2008-205618

(51) Int. Cl. H04L 12/28

(52) U.S. Cl. 370/255

(57) ABSTRACT

A communication parameter providing apparatus capable of providing a plurality of communication parameter sets to a reception apparatus. The communication parameter selects a communication parameter set which is suitable for and provided to the reception apparatus, based on a device type of the reception apparatus included in a message of automatic communication parameter setting protocol processing.

### BACKGROUND OF THE INVENTION

1. Field of the Invention

The present invention relates to a communication apparatus capable of providing a plurality of communication parameter sets to another communication apparatus and to a control method therefor.

2. Description of the Related Art

There are many setting items to be set in each of wireless local area networks (LANs) (hereinafter referred to as wireless LANs) compliant with the IEEE 802.11 standard family prior to use thereof. The setting items are, for example, communication parameters, such as a network identifier called a service set identifier (SSID), an encryption method, an encryption key, and an authentication method, which are needed to perform wireless communications.

It is very cumbersome for a user to manually input all such communication parameters. Thus, an automatic setting method for easily setting communication parameters in a wireless apparatus has been devised.

Recently, a group called Wireless-Fidelity (Wi-Fi (a registered trademark)) Alliance has completed the formulation of a standard called Wi-Fi Protected Setup (WPS) as a method for automatically setting a communication parameter. This standard has already been mounted on some products (see an article titled “Wi-Fi CERTIFIED™ for Wi-Fi Protected Setup: Easing the User Experience for Home and Small Office Wi-Fi® Networks” (for more information, visit the following Web site: http://www.wi-fi.org/wp/wifi-protected-setup)).

In the following description, a set of communication parameters (e.g., an SSID, an encryption method, an encryption key, and an authentication method) set by executing automatic communication parameter setting processing is referred to as a “communication parameter set”.

According to a WPS method, a communication parameter providing apparatus (hereinafter referred to simply as a providing apparatus) provides a communication parameter set to a communication parameter reception apparatus (hereinafter referred to simply as a reception apparatus) using predetermined procedures and messages.

The reception apparatus can perform wireless LAN communication by setting the provided communication parameter therein. According to the WPS method, a communication parameter set provided from a providing apparatus to a reception apparatus is referred to as a “credential”.

Among currently commercially available WPS-compliant apparatuses, there is one WPS-compliant apparatus that can provide a plurality of communication parameter sets to a reception apparatus by performing WPS-processing once.

Recently, an access point capable of constructing a plurality of networks using different SSIDs has been commercially available (i.e., a multiple-SSID-compliant access point).

In addition, an access point which is compliant with a plurality of standards, e.g., 802.11a/b/c/g/n and capable of utilizing both of a 2.5 GHz-band and a 5 GHz-band (i.e., a dual-band compliant access point) is commercially available.

When a multiple-SSID-compliant access point is operated as a providing apparatus by mounting the WPS standard thereon, it is possible to provide a plurality of communication parameter sets each of which has an SSID different from one another to a reception apparatus. Similarly, when a dual-band-compliant access point is operated as a providing apparatus by mounting the WPS standard thereon, it is possible to provide a plurality of communication parameter sets each of which has a communication standard or frequency band different from one another to a reception apparatus.

When a plurality of communication parameter sets are provided to a reception apparatus, the reception apparatus is required to execute a process for selecting one of the provided plurality of communication parameter sets as the communication parameter set to be set therein. For example, there may be a method in which a user selects a communication parameter set from the provided plurality of communication parameter sets. However, the method may reduce users' convenience.

Meanwhile, sometimes, a communication parameter set, which cannot be used by a reception apparatus due to limited ability thereof, is provided to the reception apparatus. For example, when a communication parameter set including an advanced encryption standard (AES) method as an encryption method is provided to a reception apparatus which cannot use the AES method as an encryption method, the reception apparatus cannot perform wireless communication using the communication parameter set provided thereto.

Even when a reception apparatus can use a communication parameter set provided thereto, a communication parameter set suitable for an application program to be used in the reception apparatus and for a communication environment is not always set therein.

For example, a load for an AES encryption process is larger than a load for each of other encryption processes. Thus, another process such as a communication process may be affected according to capability of the reception apparatus.

Consequently, even when the reception apparatus is compliant with AES, a communication rate maybe reduced by using AES. AS a result, operability by users may be deteriorated.

### SUMMARY OF THE INVENTION

The present invention is directed to a communication apparatus for solving a problem which can occur when a plurality of communication parameter sets are provided to the communication apparatus.

According to an aspect of the present invention, a communication apparatus capable of providing a plurality of communication parameter sets to another communication apparatus includes, an identification unit configured to identify a device type of the another communication apparatus, a selection unit configured to select a communication parameter set to be provided to the another communication apparatus, based on the device type of the another communication apparatus identified by the identification unit, and a providing unit configured to provide a communication parameter set selected by the selection unit to the another communication apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a providing apparatus according to an exemplary embodiment of the present invention.

FIG. 2 is a functional block diagram illustrating functions of software used in the providing apparatus according to the exemplary embodiment of the present invention.

FIG. 3 illustrates a configuration of a network according to a first exemplary embodiment of the present invention.

FIG. 4 illustrates a sequence of an automatic communication parameter setting process according to the first exemplary embodiment of the present invention.

FIG. 5 is a flowchart illustrating a process performed by the providing apparatus according to the first exemplary embodiment.

FIG. 6 is a flowchart illustrating a communication parameter set selection process performed by the providing apparatus according to the first exemplary embodiment of the present invention.

FIG. 7 illustrates a configuration of a network according to a second embodiment of the present invention.

FIG. 8 is a flowchart illustrating a communication parameter set selection process performed by the providing apparatus according to the second exemplary embodiment of the present invention.

### DETAILED DESCRIPTION OF THE EMBODIMENTS

Various exemplary embodiments, features, and aspects of the invention will be described in detail below with reference to the drawings.

Hereinafter, a communication apparatus according to a first exemplary embodiment is described in detail with reference to the accompanying drawings.

Although an example using a wireless LAN system compliant with the Institute of Electrical and Electronics Engineers (IEEE) 802.11 family for wireless communication is described below, a communication method is not necessarily limited to a wireless LAN using a wireless LAN system compliant with the IEEE 802.11 family.

An automatic communication parameter setting process using a WPS method is described below. However, the present invention can be applied to other automatic communication parameter setting processes.

A hardware configuration of the present exemplary embodiment is described below.

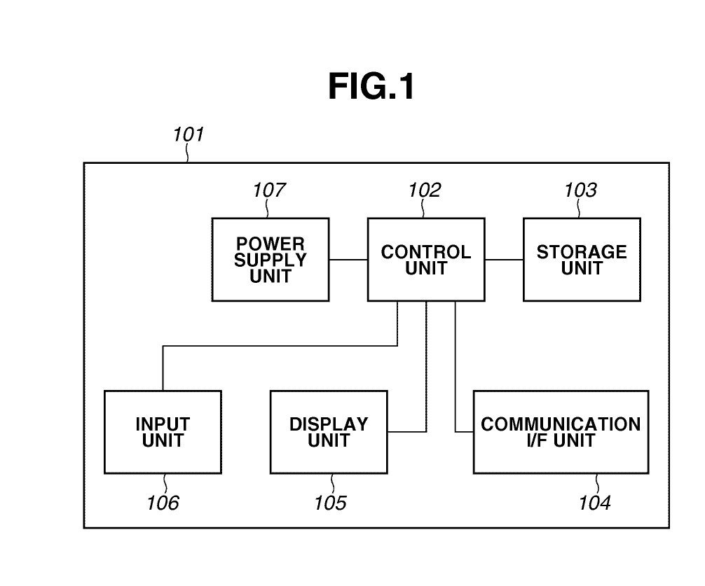

FIG. 1 is a block diagram illustrating an example of a configuration of a communication apparatus (hereinafter referred to as a providing apparatus) according to the present exemplary embodiment.

A control unit 102 controls the entire providing apparatus 101 by executing a control program stored in a storage unit 103. The control unit 102 also controls an automatic communication parameter setting process to be performed between the providing apparatus and another communication apparatus.

The storage unit 103 stores a control program to be executed by the control unit 102, and various types of information such as communication parameters. Various operations described below are performed by the control program stored in the storage portion 103 executed by the control unit 102.

A communication interface (I/F) unit 104 communicates with an external apparatus when they are connected using, for example, an Ethernet standard or an IEEE 1394 standard.

A display unit 105 displays various types of information. The display unit 105 has functions for outputting visually recognizable information, like a liquid crystal display (LCD) or a light emitting diode (LED), and for outputting sounds, like a speaker.

An input unit 106 is used by a user to input various types of information, for example, authentication information (a personal identification number (PIN) code) used for determining whether a communication parameter set is allowed to provide to another communication apparatus in an automatic communication parameter setting process. The input unit 106 is also used to input a trigger signal when an automatic communication parameter setting process is started. A power supply unit 107 supplies electric power to the entire providing apparatus 101.

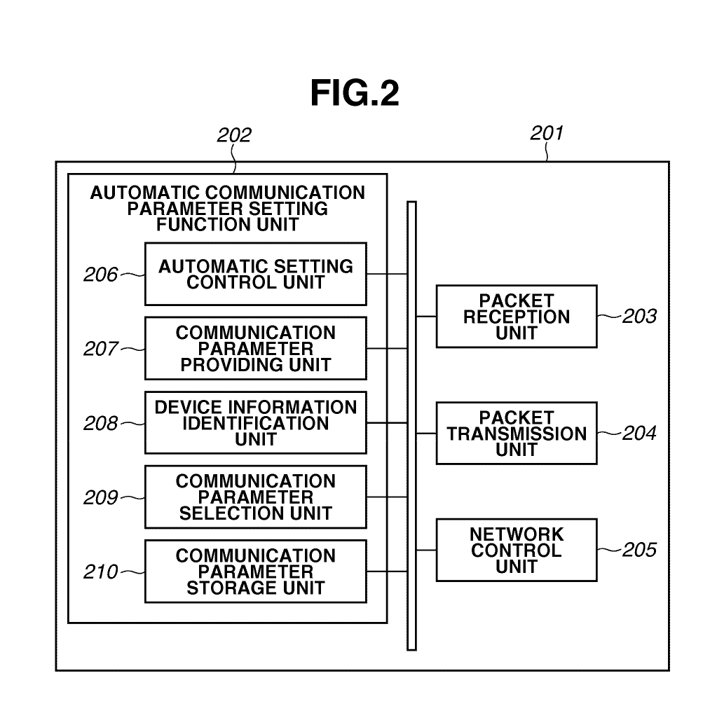

FIG. 2 is a functional block diagram illustrating an example of a configuration of software functional blocks respectively corresponding to functions performed by the providing apparatus according to the present exemplary embodiment.

A block 201 corresponds to the entire functions of the providing apparatus 101. An automatic communication parameter setting function block 202 performs an automatic communication parameter set setting of communication parameters, such as a network identifier called an SSID, an encryption method, an encryption key, and an authentication method, which are needed to perform wireless LAN communications.

This communication parameter set can be set to including information representing a frequency band to be used for the wireless LAN communications, or information representing communication standards, such as 802.11a/b/g/n to be compliant with.

A packet reception unit 203 receives packets of various communications. A packet transmission unit 204 transmits packets of various communications.

A network control unit 205 controls connection of the providing apparatus 101 to a network, and disconnection of the providing apparatus 101 from the network.

In the automatic communication parameter setting function unit block 202, an automatic setting control unit 206 controls various protocols required in an automatic communication parameter setting. That is, an automatic communication parameter setting process, which will be described below, is performed under the control of the automatic setting control unit 206.

A communication parameter providing unit 207 provides a communication parameter set to another communication apparatus. A device information identification unit 208 identifies device information of a communication parameter reception apparatus (hereinafter referred to simply as a reception apparatus) to which a communication parameter set is provided from the providing unit 207.

A communication parameter selection unit 209 selects, based on the device information identified by the device information identification unit 208, a communication parameter set to be provided, from among a plurality of communication parameter sets stored in the communication parameter storage unit 210.

The communication parameter storage unit 210 stores a plurality of communication parameter sets. The communication parameter storage unit 210 corresponds to the storage unit 103.

All of the functional blocks have an interrelationship with one another from a software point of view or a hardware point of view. The above-described functional blocks are only an example. A plurality of functional blocks can be constituted in single functional block. Any one of the above-described functional blocks can be divided into a plurality of functional blocks.

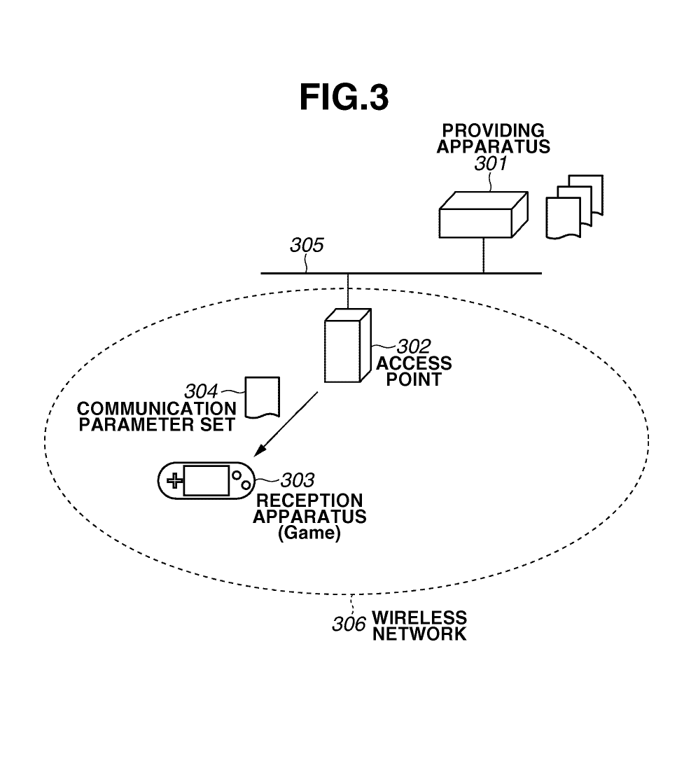

FIG. 3 illustrates a configuration of a network according to the present exemplary embodiment. A providing apparatus 301 has the above-described configuration illustrated in FIGS. 1 and 2. When dedicated software is installed in a personal computer (PC), the PC can be operated as a providing apparatus.

An access point (base station) 302 constitutes a wireless network 306. The providing apparatus 301 and the access point 302 are wire-connected and can communicate with each other. A communication parameter set 304 for a wireless network 306 constituted by the access point 302 is stored in the communication parameter storage unit 210 of the providing apparatus 301.

A communication apparatus 303 newly participates in the wireless network 306. A communication parameter set is provided to the communication apparatus 303 by performing an automatic communication parameter setting between the providing apparatus 301 and the communication apparatus 303 via the access point 302. That is, the communication apparatus 303 is a reception apparatus for receiving a communication parameter set.

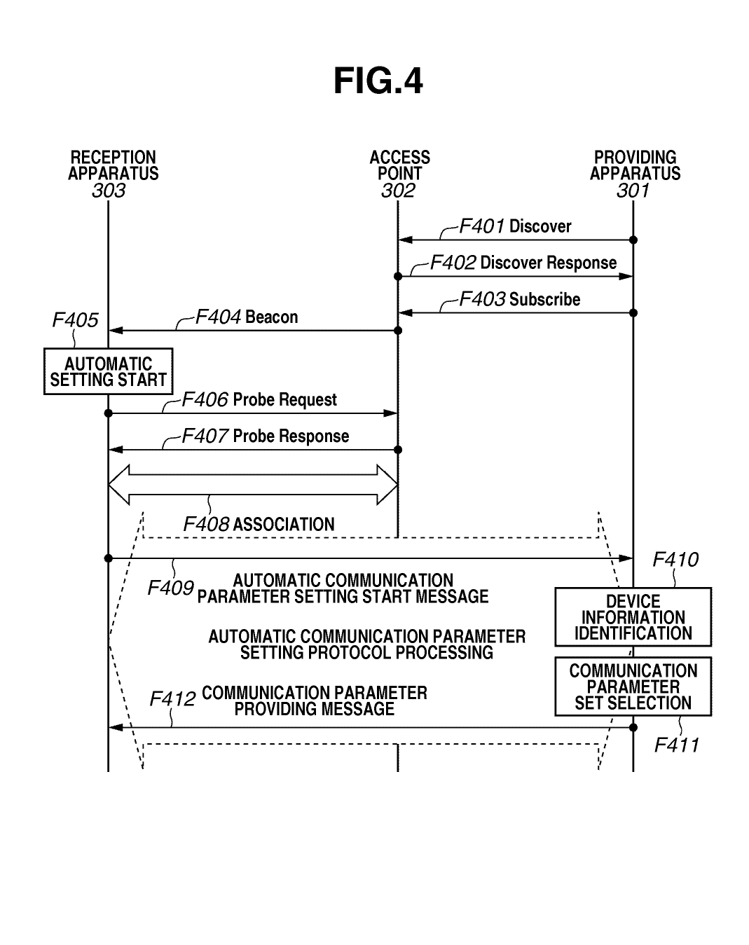

The automatic communication parameter setting process according to the present exemplary embodiment is described below with reference to FIGS. 4, 5, and 6.

FIG. 4 illustrates a sequence of the automatic communication parameter setting process performed among the reception apparatus 303, the access point 302, and the providing apparatus 301.

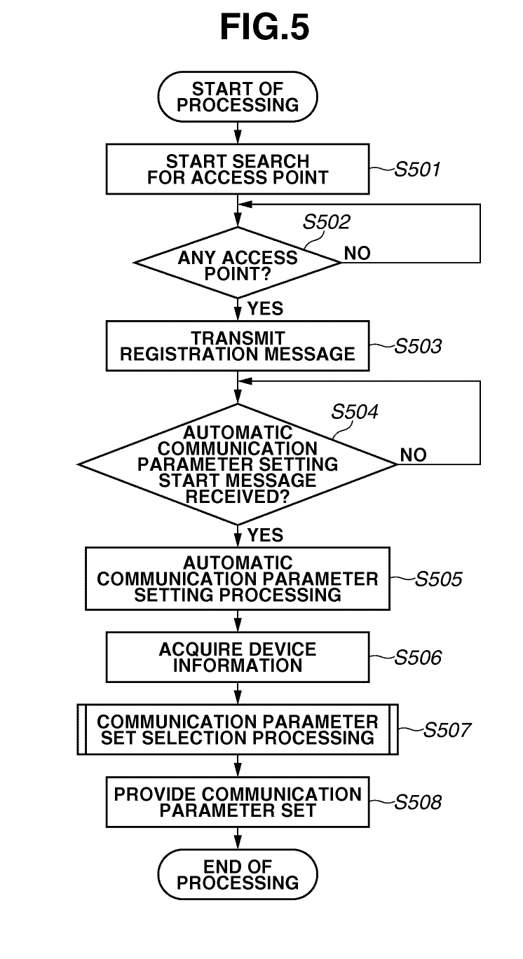

FIG. 5 is a flowchart illustrating a process performed by the providing apparatus 301.

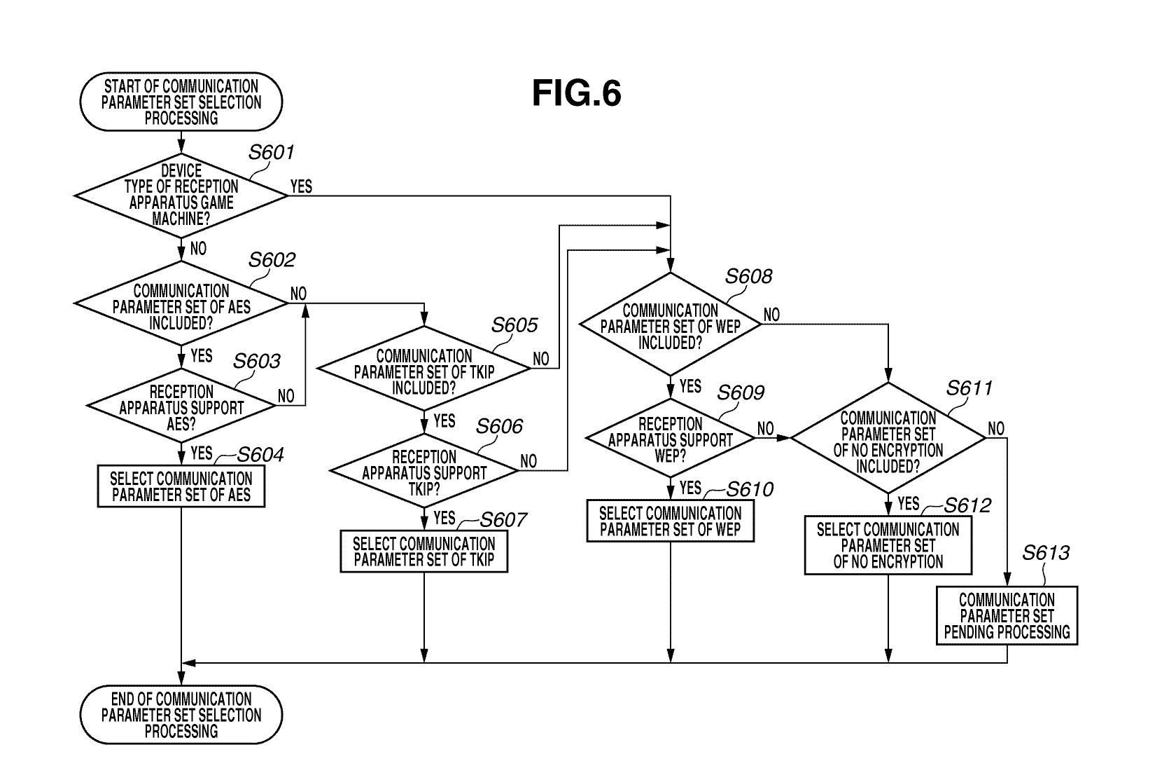

FIG. 6 is a flowchart illustrating a communication parameter set selection process performed in step S507 illustrated in FIG. 5 by the providing apparatus 301.

First, in step S501, when the providing apparatus 301 is connected to a network, the providing apparatus 301 transmits a discovery message F401 to search for an access point.

When the providing apparatus 301 receives a discovery response message F402 from the access point 302 (Yes in step S502), then in step S503, the providing apparatus 301 transmits to the access point 302 a registration message F403 for registering the apparatus 301 therein as a providing apparatus.

When the access point 302 receives the registration message F403, the access point 302 registers the providing apparatus 301 as a providing apparatus for performing an automatic communication parameter setting process. Upon completion of registration of the providing apparatus 301, an automatic communication parameter setting process can be performed between the reception apparatus 303 and the providing apparatus 301 via the access point 302.

If the providing apparatus 301 is not registered, transmission and reception of various messages relating to the automatic communication parameter setting process are not performed even though the providing apparatus 301 is connected to the access point 302.

Upon completion of registration of the providing apparatus 301, the access point 302 starts transmission of a beacon signal (information signal) F404 to which additional information is added. The additional information indicates that an automatic communication parameter setting process can be performed.

If the providing apparatus 301 is not registered, a beacon signal, to which additional information indicating that an automatic communication parameter setting process can be performed is not added, is periodically transmitted from the access point 302, though that is not illustrated in the drawings.

According to the present exemplary embodiment, it is assumed that the reception apparatus 303 issues an instruction F405 to start an automatic communication parameter setting process. Such an instruction is issued by, for example, pushing an automatic setting process start button by a user.

When an instruction to start an automatic communication parameter setting process is issued, the reception apparatus 303 searches for an access point capable of performing an automatic communication parameter setting process.

The reception apparatus 303 transmits a probe request F406 to search for an access point which can perform an automatic communication parameter setting process.

When receiving the probe request signal F406, the access point 302 sends back a probe response F407 to which additional information indicating that an automatic communication parameter setting process can be performed is added.

When receiving the probe response F407, the reception apparatus 303 can recognizes that the access point 302 can perform an automatic communication parameter setting process.

If the access point 302 has not registered the providing apparatus 301, the access point 302 sends back a probe response to which additional information indicating that an automatic communication parameter setting process can be performed is not added.

As described above, an active scan method, in which a probe request is transmitted and a prove response (a reply to the probe request) is received, is performed to determine whether the access point 302 can perform an automatic communication parameter setting process.

As described above, additional information indicating that the access point 302 can perform an automatic communication parameter setting process is also added to a beacon signal transmitted by the access point 302. Thus, a passive scan method (i.e., monitoring reception of a beacon signal) can be employed. In addition, the active scan method and the passive scan method can be used together.

Subsequently, the reception apparatus 303 performs association using an SSID included in the probe response F407 to perform temporal wireless connection F408 with the access point 302.

When the association is completed, encryption keys or the like are not matched with each other even though the SSIDs are matched with each other. Thus, normal data communication using the encryption method and the authentication method cannot be performed.

The reception apparatus 303 starts performing automatic communication parameter setting protocol processing with the providing apparatus 301 via the access point 302 using an extensible authentication protocol (EAP) packet. The EAP packet is a packet allowing communications between the providing apparatus and the reception apparatus without performing encryption and authentication.

An automatic communication parameter setting protocol processing is started by transmitting a start message F409 using an EAP packet from the reception apparatus 303 to the providing apparatus 301.

When receiving an automatic communication parameter setting protocol processing start message (Yes in step S504), then in step S505, the providing apparatus 301 starts performing automatic communication parameter setting protocol processing.

By the automatic communication parameter setting protocol, an encryption process of encrypting a communication channel, and an authentication process for determining whether a communication parameter set can be provided to another communication apparatus are performed.

Transmission and reception of various messages for performing these processes are performed between the providing apparatus 301 and the reception apparatus 303. All or part of various messages transmitted from the reception apparatus 303 includes device information of the reception apparatus 303.

The device information includes device types, such as a PC, a game machine, or a digital camera, and device capability. The device capability includes available encryption methods (e.g., an advanced encryption standard (AES) method, a temporal key integrity protocol (TKIP) method, and a wired equivalent privacy (WEP) method), authentication methods (e.g., an open authentication method, a shared key authentication method, a Wi-Fi protected access (WPA) authentication method, a WPA—Pre-shared key(WPA-PSK) authentication method, a WPA2 authentication method, and a WPA2-PSK authentication method), and a communication standard (e.g., 802.11a/b/g/n).

In step S506, the automatic communication parameter setting protocol is performed. Thus, the providing apparatus 301 can acquire the device information of the reception apparatus 303. In addition, the providing apparatus 301 can identify the device information thereof (F410).

In step S507, the providing apparatus 301 performs a communication parameter set selection process F411 for selecting a communication parameter set to be provided to another communication apparatus, based on the acquired device information.

According to the present exemplary embodiment, it is assumed that the providing apparatus 301 stores a plurality of communication parameter sets, which differ from one another in encryption method, as the communication parameter set for the access point 302. The encryption methods includes AES, TKIP, WEP, and no encryption.

Such encryption methods are arranged in a descending order of encryption intensity as follows: AES>TKIP>WEP>no encryption. On the other hand, such encryption methods are arranged as follows in a descending order of each of a magnitude of a processing load and a length of a processing time required to perform such encryption methods: AES>TKIP>WEP>no encryption.

Accordingly, even when an encryption method having a high encryption intensity is utilized, the encryption method may give a small effect on communication processing of an apparatus such as a PC, which has a central processing unit (CPU) with high processing ability. On the other hand, when an encryption method having high encryption intensity is utilized in an apparatus such as a game machine, which has relatively low processing ability, a communication processing speed may be low. In this case, even though a security level is somewhat low, it is advisable to use an encryption method whose processing load is low.

According to the present exemplary embodiment, it is assumed that at the access point 302, communications using AES, TKIP, and WEP methods as encryption methods can be performed, and that the providing apparatus 301 stores communication parameter sets “A”, “B”, and “C” for the AES method, TKIP method, and WEP method, respectively.

For example, as the communication parameter set “A”, “SSID: abc, encryption method: AES, encryption key: an encryption key used in the AES, authentication method: WPA2” is stored.

In addition, as the communication parameter set B, “SSID: abc, encryption method: TKIP, encryption key: encryption key used in the TKIP method, authentication method: WPA” is stored. As the communication parameter set “C”, “SSID: abc, encryption method: WEP, the encryption key: encryption key used in the WEP method, authentication method: open authentication” is stored.

The reception apparatus 303 is assumed to be TKIP-compliant and WEP-compliant (i.e., the TKIP method and the WEP method can be used in the reception apparatus 303). As described above, information representing usable encryption methods is included in messages generated in the automatic communication parameter setting protocol processing and is transmitted from the reception apparatus 303 to the providing apparatus 301.

In the present exemplary embodiment, in step S507, in a communication parameter set selection process, the providing apparatus 301 selects a communication parameter set to be provided thereto, according to the device type of the reception apparatus 301 and the usable encryption method.

In the communication parameter set selection process, first, in step S601, the providing apparatus 301 determines whether the device type of the reception apparatus 303 is a game machine. If the device type of the reception apparatus 303 is not a game machine (No in step S601), a communication parameter set of an encryption method, whose encryption intensity is highest among the encryption methods usable by the reception apparatus 303, is provided thereto.

If the device type of the reception apparatus 303 is a game machine (Yes in step S601), importance is placed on a communication processing speed rather than security intensity, and a communication parameter set, the encryption intensity of which is relatively low (e.g., lower than that of the WEP method) and the processing speed of which is relatively high, is provided to the reception apparatus 303. If the device type of the reception apparatus 303 is a game machine (Yes in step S601), the process proceeds to step S608. If the device type of the reception apparatus 303 is not a game machine (No in step S601), the process proceeds to step S602.

In step S602, the providing apparatus 301 determines whether the providing apparatus 301 stores a communication parameter set for the AES method. If the providing apparatus 301 stores a communication parameter set for the AES encryption method (Yes in step S601), the process proceeds to step S603. If the providing apparatus 301 does not store a communication parameter set for the AES encryption method (No in step S601), the process proceeds to step S605.

In step S603, the providing apparatus 301 determines whether the reception apparatus 303 supports AES, based on the acquired device information. If the reception apparatus 303 supports AES (Yes in step S603), then in step S604, the providing apparatus 301 selects a communication parameter set for the AES method as the communication parameter set to be provided thereto. Then, the communication parameter set election process is finished. If the reception apparatus 303 does not support AES (No in step S603), the process proceeds to step S605.

In step S605, the providing apparatus 301 determines whether the providing apparatus 301 stores a communication parameter set for the TKIP method, the encryption intensity of which is higher next to that of the AES method. If the providing apparatus 301 stores a communication parameter set for the TKIP method (Yes in step S605), the process proceeds to step S606. If the providing apparatus 301 does not store a communication parameter set for the TKIP method (No in step S605), the process proceeds to step S608.

In step S606, the providing apparatus 301 determines whether the reception apparatus 303 supports TKIP, based on the acquired device information. If the reception apparatus 303 supports TKIP (Yes in step S606), then in step S607, the providing apparatus 301 selects a communication parameter set for the TKIP method as the communication parameter set to be provided to the reception apparatus 303. When the communication parameter set to be provided thereto is selected, the communication parameter set selection process is finished.

In step S608, the providing apparatus 301 determines whether the providing apparatus 301 stores a communication parameter set for the WEP method as the encryption method. If the providing apparatus 301 stores a communication parameter set for the WEP method (Yes in step S608), the process proceeds to step S609. If the providing apparatus 301 does not store a communication parameter set for the WEP method (No in step S608), the process proceeds to step S611.

In step S609, the providing apparatus 301 determines whether the reception apparatus 303 supports WEP, based on the acquired device information. If the reception apparatus 303 supports WEP (Yes I step S609), then in step S610, the providing apparatus 301 selects a communication parameter set for a WEP method, as the communication parameter set to be provided to the reception apparatus 303. If the reception apparatus 303 does not support WEP (No in step S609), the process proceeds to step S611.

In step S611, the providing apparatus 301 determines whether the providing apparatus 301 stores a communication parameter set for no encryption method. If a communication parameter set for no encryption method is set, encryption of data is not performed. If the providing apparatus 301 stores a communication parameter set for no encryption method (Yes in step S611), then in step S612, the providing apparatus selects this communication parameter set as a communication parameter set to be provided to the reception apparatus 303.

If the providing apparatus 301 does not store a communication parameter set for no encryption method (No in step S611), a communication parameter set to be provided thereto is determined to be pendent. Then, in step S613, the communication parameter set selection process is finished. In this case, no communication parameter set is provided thereto. The providing apparatus 301 may transmit an error notification indicating that there is no appropriate communication parameter set.

According to the present exemplary embodiment, the device type of the reception apparatus 303 is assumed to be a game machine. In this case, even when the reception apparatus 303 is TKIP-compliant, a communication parameter set C (a communication parameter set for the WEP method as the encryption method) for the WEP method, as the encryption method. The encryption intensity of the WEP is lower than that of the TKIP method.

Thus, in step S508, the communication parameter set selected by the providing apparatus 301 is included in a communication parameter providing message F412 and transmitted to the reception apparatus 303. As described above, according to the present exemplary embodiment, the communication parameter set “C” is provided thereto. Upon completion of providing the communication parameter set, the reception apparatus S303 and the providing apparatus S301 finish the automatic communication parameter setting process.

The reception apparatus S303 can be connected to the access point 302 by setting the provided communication parameter set “C” therein. Data communication using a WEP encryption method can be performed.

Thus, according to the present exemplary embodiment, the providing apparatus selects a communication parameter set for the encryption method that is suitable for the device type of the reception apparatus from among a plurality of communication parameter sets stored therein. Thus, it is not necessary to perform the communication parameter set selection process in the reception apparatus.

Among candidates for the communication parameter set to be provided to the reception apparatus, which are extracted according to the device type of the reception apparatus, the communication parameter set for the encryption method, which is highest in encryption intensity among encryption methods supported by the reception apparatus, is provided to the reception apparatus thereto. Accordingly, a communication parameter set for the encryption method having low encryption intensity, can be prevented from being set by a user's erroneous operation.

Consequently, even a beginner can achieve setting of an appropriate communication parameter set in consideration of the security intensity and the processing speed. Accordingly, user-friendliness can be enhanced.

In the present exemplary embodiment, a candidate for a communication parameter set to be provided to the reception apparatus is changed according to whether the device type of the reception apparatus is a game machine. However, another device type can be used as a condition for determination.

When the device type is, for example, a PC, a communication parameter set for the encryption method, which is highest in encryption intensity among encryption methods usable by the PC, may be selected by placing importance on security. When the reception apparatus is low in processing speed and performs only temporal wireless communications, a communication parameter set for no encryption method can be selected, regardless of encryption methods usable by the reception apparatus.

Thus, according to the device type of each reception apparatus, a communication parameter set appropriate for a data processing speed by an application program and the security intensity of the reception apparatus can be provided thereto.

Information for selecting a communication parameter set, in addition to the device type, is not limited to the encryption method. The selection of a communication parameter set can be performed, based on another kind of device capability.

For example, a communication parameter set to be provided thereto can be selected, based on the device type of the reception apparatus and the authentication method supported by the reception apparatus. When the authentication method is used, the automatic communication parameter setting process can be achieved by replacing the expression “encryption method” with the expression “authentication method” in the above description of the present exemplary embodiment.

Alternatively, a communication parameter set to be provided thereto can be selected, based on, for example, the device type of the reception apparatus and the communication standards (e.g., Institute of Electrical and Electronics Engineers (IEEE) 802.11a/b/g/n) which the reception apparatus conforms to. For example, an access point conforms to each of the communication standards (IEEE 802.11a/b/g/n), and a communication parameter set for each of the communication standards is stored in the providing apparatus.

For example, when both of a PC and a television set are compliant with each of the communication standards (e.g., IEEE 802.11a and 802.11b), a communication parameter set for the communication standard IEEE 802.11a is provided to a television set, which may perform stream communication, in order to perform high-speed communication. A communication parameter set for the communication standard IEEE 802.11b can be provided to a PC, which may perform mainly packet communication.

In the providing apparatus, an item on which importance is placed when wireless communication is performed, can be set for each device type. Device information to be used as a criterion for selecting a communication parameter set to be provided to the reception apparatus can be changed according to the set item.

For example, when the device type is set to be a “security preference apparatus”, a communication parameter set may be selected, based on the encryption method and/or the authentication method. When the device type is set to be a “communication speed preference apparatus”, a communication parameter set can be selected, based on the communication standards (e.g., IEEE 802.11a/b/g/n).

These are examples for selecting a communication parameter, and a communication parameter is not limited to those. That is, as long as appropriate communication parameters can be obtained based on a device type acquired from the reception apparatus and a part of or a plurality of device abilities, any method can be used.

Each message transmitted by the reception apparatus in the automatic communication parameter setting protocol processing does not always include an encryption method, an authentication method, and a communication standard. Only a part of the encryption method, the authentication method, and the communication standard can be included in each message transmitted by the reception apparatus.

Even in such a case, a communication parameter set, which is as appropriate for the reception apparatus as possible, can be selected and provided by the providing apparatus, based on the device ability included in such a message. Alternatively, regardless of the device abilities (e.g., the encryption method, the authentication method, and the communication standard) of the reception apparatus, a communication parameter set to be provided thereto can be selected only based on the device type of the reception apparatus.

For example, when a plurality of communication parameter sets respectively for the standards IEEE 802.11a and 802.11b, which differ from each other in used frequency band, can be provided, the communication parameter sets respectively for the standards IEEE 802.11a and 802.11b can selectively be provided thereto according to whether the reception apparatus is a television set.

When a plurality of communication parameter sets, which differ from each other in the encryption method, can be provided, a communication parameter set for the WEP method and a communication parameter set for the AES or TKIP method can be selectively provided according to whether the reception apparatus is a game machine.

Most of apparatuses may be able to conform to all of encryption methods, authentication methods, and communication standards in future. Even in such a case, the providing apparatus can provide appropriate communication parameters only by checking the device type of the reception apparatus.

In the present exemplary embodiment, the case has been described, in which one communication parameter set to be provided to the reception apparatus is selected by the providing apparatus based on the device type and the device capability of the reception apparatus. However, the providing apparatus can provide a plurality of communication parameter sets thereto.

The providing apparatus can be configured such that, for example, among candidates for a communication parameter set to be provided, which differ from one another according to the device type of the reception apparatus, the providing apparatus provide all of communication parameter sets for the encryption methods supported by the reception apparatus. In this case, it is useful that the reception apparatus displays the provided plurality of communication parameter sets so that a user can select a communication parameter set to be set.

Thereby, a user can select from a communication parameter set among the communication parameter sets suitable for the reception apparatus according to an application program to be used and a communication environment.

When a plurality of communication parameter sets are provided, each communication parameter set can be transmitted with priority information. In this case, it is useful to add priority information to one or more of the encryption method, the authentication method, and the communication standard.

The reception apparatus may automatically set a highest-priority communication parameter set from among a plurality of communication parameter sets provided thereto. Alternatively, the reception apparatus may display the communication parameter sets provided thereto, for example, in a descending order of priority so that a user can select one of the communication parameter sets.

Thus, the reception apparatus can select a communication parameter set based on priority by providing each communication parameter set thereto with the priority information.

Alternatively, the providing apparatus may determine whether the providing apparatus provides all communication parameter sets or a part of the communication parameter sets, according to the device type of the reception apparatus.

For example, the providing apparatus may transmit all communication parameter sets to an apparatus having an enough user interface (UI) function, while the providing apparatus provides a part of the communication parameter sets to an apparatus having a poor UI function according to the device capability of this apparatus.

For example, when the device type of the reception apparatus is a PC, the PC has an enough UI function, so that the PC can easily select a communication parameter set. Thus, it is useful to transmit all the communication parameter sets from the providing apparatus to the PC so that a user can select one of the communication parameters.

Alternatively, when the device type of the reception apparatus is a digital camera, the digital camera has a poor UI function. Thus, it is useful that one of the communication parameter sets is transmitted to the digital camera.

Thus, a communication parameter set suitable for the UI function of each communication apparatus can be provided according to the device type of the reception apparatus.

Thus, according to the present exemplary embodiment, even when there are a plurality of communication parameter sets providable by the providing apparatus, an appropriate communication parameter set can be provided according to the device information of a reception apparatus.

In addition, according to the present exemplary embodiment, device information included in each message generated in automatic setting protocol processing according to the WPS standard can be used. Therefore, processing compliant with specifications of the WPS standard can be achieved without adding special processing to acquire device information.

Hereinafter, a second exemplary embodiment of the present invention is described, which can construct a wireless network having a plurality of access points (i.e., multiple-SSID-compliant access points).

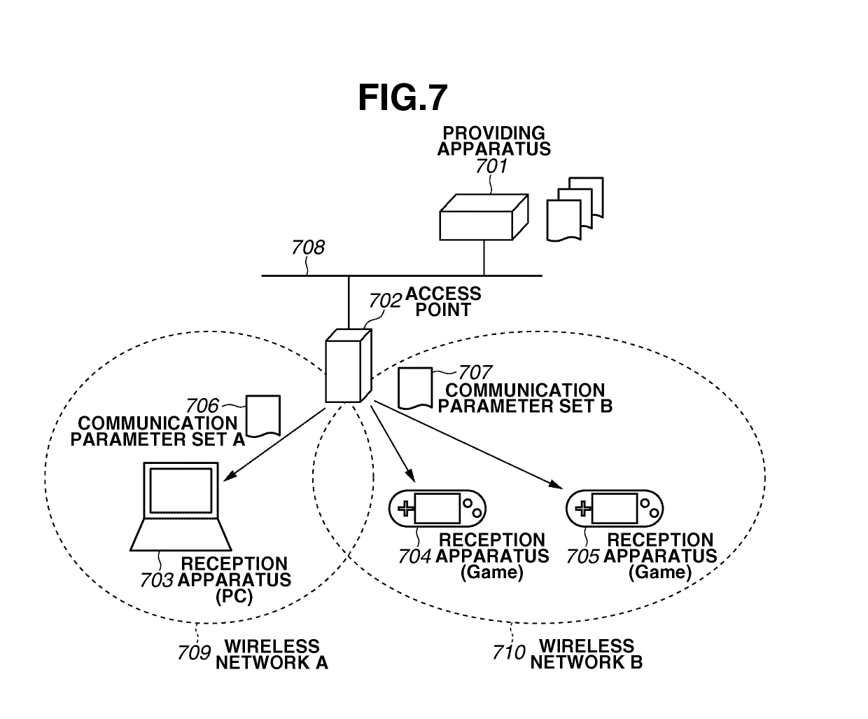

FIG. 7 illustrates a configuration of a network according to the present exemplary embodiment.

A providing apparatus 701 has a similar configuration to that illustrated in FIGS. 1 and 2 according to the first exemplary embodiment.

An access point 702 is multiple-SSID-compliant. Thus, a wireless network A (709) and a wireless network B 710), which differ from each other in SSID, can be constructed. The wireless network A (709) can be connected to the Internet. Each apparatus participating in the wireless network A (709) can be connected to the Internet via the access point 702.

The wireless network B (710) is a local network and cannot be connected to the Internet. Communication can be achieved only among apparatuses participating in the wireless network B (710).

The providing apparatus 701 is wire-connected to the access point 702 via a LAN 708 so that the providing apparatus 701 and the access point 702 can communicate with each other. A communication parameter set A (706) for the wireless network A (709), which is constructed by the access point 702, and a communication parameter set B (707) for the wireless network B (710), which is constructed by the access point 702, are stored in a communication parameter storage unit 210 of the providing apparatus 701.

For simplicity of description, it is assumed that the communication parameter set A (706) and the communication parameter set B (707) differ from each other only in SSID, and that other communication parameters such as an encryption method and an authentication method are common to both of the communication parameter set A (706) and the communication parameter set B (707).

The device type of a communication apparatus 703 is a PC. The device type of each of communication apparatuses 704 and 705 is a game machine. The communication apparatuses 703, 704, and 705 are newly connected to the access point 702. A communication parameter set is provided to each of the communication apparatuses 703, 704, and 705 by performing an automatic communication parameter setting process between the providing apparatus 701 and each of the communication apparatuses 703, 704, and 705 via the access point 702.

That is, each of the communication apparatuses 703, 704, and 705 serves as a reception apparatus for receiving a communication parameter set. For simplicity of description, it is assumed that an encryption method, an authentication method and the like for each of the communication parameter set A (706) and the communication parameter set B (707) are usable by each of the communication apparatuses 703, 704, and 705. Thus, each of the communication apparatuses 703, 704, and 705 can use both of the communication parameter set A (706) and the communication parameter set B (707).

Hereinafter, an automatic communication parameter setting process according to the present exemplary embodiment is described with reference to FIGS. 4, 5, and 8.

A sequence of a process performed between the providing apparatus 701 and each of the reception apparatuses 703, 704, and 705 according to the present exemplary embodiment is similar to that illustrated in FIG. 4. Thus, a description of this sequence is omitted. That is, the reception apparatus 301 illustrated in FIG. 4 may be replaced with each of the reception apparatuses 703, 704, and 705.

A flowchart of an operation of the providing apparatus 701 according to the present exemplary embodiment is similar to that illustrated in FIG. 5. Thus, a description of the flowchart of the operation of the providing apparatus 701 is omitted.

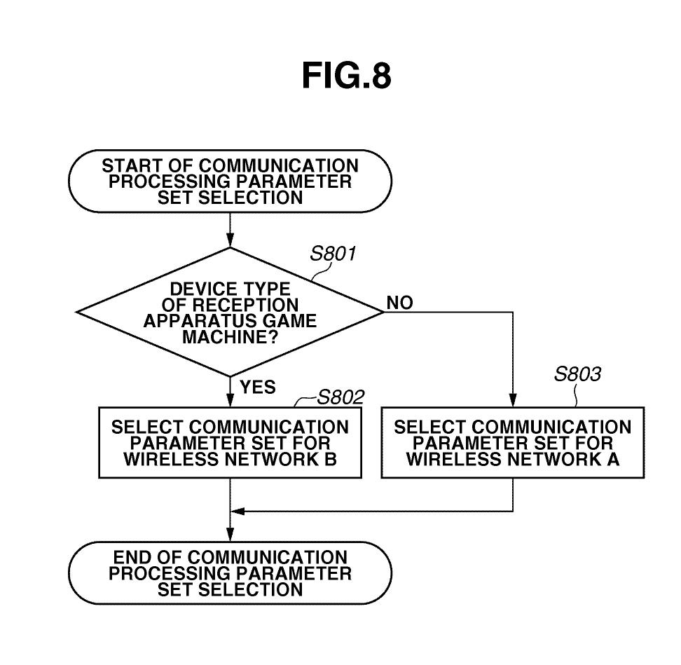

FIG. 8 is a flowchart illustrating a communication parameter set selection process (performed in step S507 illustrated in FIG. 5) performed by the providing apparatus 701 according to the present exemplary embodiment.

Hereinafter, the communication parameter set selection process (F411), in step S507, to be performed by the communication apparatus 701 is described.

The providing apparatus 701 determines the device type of a reception apparatus based on device information included in various messages according to an automatic communication parameter setting processing protocol. According to the present exemplary embodiment, in step S801, the providing apparatus 701 determines whether the device type of the reception apparatus is a game machine.

If the device type of the reception apparatus is a game machine (Yes in step S801), then in step S802, the communication parameter set B (707) for the wireless network B (710), which is a wireless local network, is selected.

If the device type of the reception apparatus is not a game machine (No in step S801), then in step S803, the communication parameter set A (706) for the wireless network A (709), which can be connected to the Internet, is selected.

Consequently, the communication parameter set A (706) is provided to the reception apparatus 703. Accordingly, the reception apparatus 703 can be connected to the Internet by being connected to the wireless network A (709).

The communication parameter set B 707 is provided to the reception apparatuses 704 and 705. Accordingly, the reception apparatuses 704 and 705 are connected to the local wireless network B (710). Consequently, communications can be performed between the game machines.

Thus, according to the present exemplary embodiment, when the network accessible via the access point is changed according to the provided communication parameter set, an appropriate communication parameter according to the device type of the reception apparatus can be selected and provided.

In the present exemplary embodiment, the case has been described, in which the communication parameter set to be provided is changed according to whether the device type is a game machine. However, another device type may be used as a criterion for determination. A finer control operation may be performed according to the device type.

For example, when the device type is a printer, a communication parameter set for the local wireless network may be provided to the reception apparatus. When the device type is a television set, a communication parameter set for the wireless network that is connectable to the Internet can be provided.

In the present exemplary embodiment, the case has been described, in which a communication parameter set to be provided is selected based on the device type of the reception apparatus. However, a communication parameter set can be selected in consideration of the device capability in addition to the device type.

For example, the providing apparatus may store a plurality of communication parameter sets different from one another in encryption method and authentication method as the communication parameter set for a wireless network connectable to the Internet. Similarly, the providing apparatus may store a plurality of communication parameter sets different from one another in encryption method and authentication method as the communication parameter set for a local wireless network.

When the device type of the reception apparatus is a digital camera, and when the reception apparatus is AES-compliant and TKIP-compliant, a communication parameter set for a wireless network connectable to the Internet is provided.

When a digital camera serving as a reception apparatus is compliant only with the WEP method, a communication parameter set for a local wireless network is provided thereto.

Consequently, the digital camera capable of achieving high-security-level wireless communications can upload image data to an external server and download data therefrom via the Internet.

When the device type of the reception apparatus is a digital camera that cannot perform high-security-level wireless communications, for example, uploading of image data is restricted. However, images can be shared by the digital camera and another digital camera.

In the present exemplary embodiment, the case has been described, in which a communication parameter set can selectively be provided from among the communication parameters for a network connectable to the Internet and for a network that is not connectable to the Internet. However, it is not limited to the Internet connection.

That is, according to the present exemplary embodiment, a communication parameter set can be selectively provided according to the device information from among communication parameter sets for when the communication apparatus is connected to an external network via the access point and for when the communication apparatus is connected to an inner network

Thus, according to the present exemplary embodiment, even when an accessible network is different depending on a communication parameter set provided by the providing apparatus, an appropriate communication parameter set can be provided according to the device information of the reception apparatus.

According to the present exemplary embodiment, device information included in each message generated in automatic setting protocol processing according to a WPS standard can be utilized. Consequently, processing according to the specifications of the WPS standard can be achieved without adding special processing to acquire device information.

In each of the above-described exemplary embodiments, the case has been described, in which the providing apparatus is wire-connected to the access point. However, the access point itself may be operated as the providing apparatus.

In this case, processing corresponding to each of messages F401 to F403 illustrated in FIG. 4, and processing corresponding to S501 to S503 are omitted. The access point can be operated as the providing apparatus, if dedicated software program is installed in the access point.

In each of the exemplary embodiments, the device type and the device capability (e.g., the encryption method, the authentication method, and the communication standard) have been described as examples of the device information. However, another type of device information can be used. For example, identification information (e.g., a model name, and a serial number), and information of an operating system (OS) version number, and a frequency band (2.4 GHz band or 5 GHz band) can be used.

In each of the embodiments, a wireless LAN compliant with the IEEE 802.11 has been described as an example. However, the present invention can be implemented using a wireless universal serial bus (USB) medium, a multi-band orthogonal frequency division multiplexing (OFDM) alliance (MBOA) medium, a Bluetooth (registered trademark) medium, an ultra-wideband (UWB) medium, a ZigBee ((registered trademark) or IEEE 802.15.4) medium, or the like. In addition, the present invention can be implemented using a wire communication medium, such as a wired LAN. The UWB medium includes a wireless USB medium, a wireless IEEE 1394 medium, a WiMedia network (WiNET) medium and the like.

A set of a network identifier, an encryption method, an encryption key, and an authentication method has been described as an example of the communication parameter set. However, the communication parameter set can include none of such information. Alternatively, the communication parameter set can include other types of information.

The present invention can be implemented by supplying a storage medium that stores program code of software capable of achieving the functions of the above-described embodiments to a system or an apparatus, and causing a computer (CPU or a microprocessor unit (MPU)) of the system or apparatus to read out and execute the program code stored in the storage medium.

In this case, the program code read from the storage medium achieve the functions of the aforementioned embodiments, while the storage medium containing the program code constitutes the present invention.

For example, a floppy disk (registered trademark), a hard disk, an optical disk, a magneto-optical disk, a compact disk read-only memory (CD-ROM), a compact disk rewritable (CD-R), a magnetic tape, a nonvolatile memory card, a read-only memory (ROM), a digital versatile disk (DVD) or the like can be used as storage media for supplying the program code.

In addition, the aforementioned functions can be achieved not only by executing program code read out by a computer, but also causing an OS or the like, which runs on a computer, to perform a part or all of actual processing.

The aforementioned functions can also be achieved by writing the program code read out by a computer into memory provided with a function expansion board inserted into a computer or a function expansion unit connected to a computer, and then causing a CPU or the like built in the function expansion board or the function expansion unit to perform a part or all of actual processing based on instructions from the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-205618 filed Aug. 8, 2008, which is hereby incorporated by reference herein in its entirety.

What is claimed is:

1. A communication apparatus capable of providing a plurality of communication parameter sets to another communication apparatus, the communication apparatus comprising:
an identification unit configured to identify a device type of the another communication apparatus;
a selection unit configured to select a communication parameter set to be provided to the another communication apparatus, based on the device type of the another communication apparatus identified by the identification unit; and
a providing unit configured to provide a communication parameter set selected by the selection unit to the another communication apparatus.

2. The communication apparatus according to claim 1, wherein the identification unit identifies the device type of the another communication apparatus, based on a message of automatic communication parameter setting protocol processing performed between the communication apparatus and the another communication apparatus.

3. The communication apparatus according to claim 1, wherein the identification unit identifies device capability of the another communication apparatus, and
wherein the selection unit selects a communication parameter set to be provided, based on the device type of the another communication apparatus identified by the identification unit, and on the device capability of the another communication apparatus.

4. The communication apparatus according to claim 3, wherein the selection unit performs a first selection process for selecting candidates for communication parameter sets to be provided to the another communication apparatus from among a plurality of communication parameter sets which the communication apparatus can provide, based on the device type of the another communication apparatus, and a second selection process for selecting a communication parameter set to be provided to the another communication apparatus, based on the device capability of the another communication apparatus, from among the candidates selected by the first selection process.

5. The communication apparatus according to claim 3, wherein the device capability includes at least one of an encryption method, an authentication method, and a communication standard, which are usable by the another communication apparatus.

6. The communication apparatus according to claim 1, wherein the selection unit selects a communication parameter set including an encryption method and an authentication method, according to the device type of the another communication apparatus, from among a plurality of communication parameter sets in which encryption method or authentication method is different from each other.

7. The communication apparatus according to claim 6, wherein the identification unit identifies the encryption method or the authentication method, which is usable by the another communication apparatus, and
wherein the selection unit selects a communication parameter set including the encryption method or the authentication method, which is usable by the another communication apparatus, from among the communication parameter sets each including an encryption method or an authentication method, according to the device type of the another communication apparatus.

8. The communication apparatus according to claim 7, wherein the selection unit selects a communication parameter set including an encryption method or an authentication method with the highest security intensity from among the communication parameter sets each including an encryption method or an authentication method, which is usable by the another communication apparatus.

9. The communication apparatus according to claim 7, wherein the selection unit selects all of communication parameter sets each including an encryption method or an authentication method, which is usable by the another communication apparatus, as communication parameter sets to be provided to the another communication apparatus.

10. The communication apparatus according to claim 1, wherein the selection unit performs a determination process for determining all or a part of a plurality of communication parameter sets from among the plurality of communication parameter sets that the providing unit can provide, based on the device type of the another communication apparatus, and selects a communication parameter set to be provided to the another communication apparatus, based on a result of the determination process.

11. The communication apparatus according to claim 1, wherein the selection unit selects a communication parameter set for a frequency band according to the device type of the another communication apparatus from among a plurality of communication parameter sets each of which has a frequency band to be used different from one another.

12. The communication apparatus according to claim 1, wherein the selection units selects a communication parameter set to be provided to the another communication apparatus, based on the device type of the another communication apparatus, from among a plurality of communication parameter sets each of which can access to a different network from one another via a base station.

13. The communication apparatus according to claim 1, wherein the selection unit selects a communication parameter set to be provided to the another communication apparatus, based on the device type of the another communication apparatus, from among a plurality of communication parameter sets each of which has a different network identifier from one another.

14. The communication apparatus according to claim 1, wherein the communication apparatus serves as a wireless communication base station.

15. A method for controlling a communication apparatus capable of providing a plurality of communication parameter sets to another communication apparatus, the method comprising:
identifying a device type of the another communication apparatus;
selecting a communication parameter set to be provided thereto, based on the identified device type of the another communication apparatus; and
providing the selected communication parameter set to the another communication apparatus.

16. A computer-readable storage medium storing a computer program instructions for causing a computer to function as the communication apparatus according to claim 1.
